(19) United States
(12) Patent Application Publication
(10) Pub. No.: US 2026/0259407 A1
(43) Pub. Date: Sep. 3, 2026

(54) WINDSHIELD DISPLAY SYSTEM

(71) Applicant: HYUNDAI MOBIS CO., LTD., Seoul (KR)

(72) Inventor: Gwan Hee LEE, Yongin-si (KR)

(73) Assignee: HYUNDAI MOBIS CO., LTD., Seoul (KR)

(21) Appl. No.: 19/067,006

(22) Filed: Feb. 28, 2025

(51) Int. Cl. G02B 27/01; B60K 35/231

(52) U.S. Cl. CPC G02B 27/0101; B60K 35/231; G02B 2027/0118; G02B 2027/014; G02B 2027/0192

(57) ABSTRACT

A windshield display system is provided. The system includes a photosensitive area formed on at least a portion of a windshield of a vehicle by coating ultraviolet photosensitive agent or attaching an ultraviolet photosensitive film to the windshield, the photosensitive area changes transparency based on incident ultraviolet light, a reflective display formed on a lower part of the windshield and outputs an image and reflects the image onto the photosensitive area, and a controller to receive signals from the outside, generate image information based on the received signals, and transmit the image information to the reflective display.

### BACKGROUND

### 1. Field of the Invention

The present invention relates to a windshield display system, and more particularly, to a windshield reflective display system capable of being operated with low power while securing a wider field of view for the driver.

### 2. Description of the Related Art

A windshield reflective display is a display method that projects information onto the front windshield of a vehicle. The windshield reflective display allows the driver to check information while looking ahead, which can improve driving safety.

There are two main types of windshield reflective displays. One method involves attaching a reflective film or applying a reflective coating to a portion of the windshield and reflecting an image onto that area, while the other method involves inserting a transparent display panel into the windshield. In general, considering the complexity of the process and costs, the former method is more commonly used in implementing windshield reflective displays.

In a windshield reflective display, if the reflective area formed on a portion of the windshield is transparent, it is easy for the driver to maintain visibility; however, very high brightness is required to make the information displayed in that area readable, which leads to increased power consumption. On the other hand, if the reflective area formed on a portion of the windshield is opaque, the area obstructs the view ahead, making it difficult for the driver to maintain visibility.

### SUMMARY

The present invention has been conceived to solve the above problems, and it is an object of the present invention to provide a windshield reflective display system capable of improving the visibility of various information necessary for vehicle operation, which is the original purpose of the windshield reflective display, while allowing the driver to secure a relatively wide field of view depending on the situation, and operating more efficiently by reducing power consumption.

In a general aspect of the disclosure, a windshield display system includes: a photosensitive area formed on at least a portion of a windshield of a vehicle by coating ultraviolet photosensitive agent or attaching an ultraviolet photosensitive film to the windshield, the photosensitive area configured to change transparency based on incident ultraviolet light; a reflective display formed on a lower part of the windshield and configured to output an image and reflect the image onto the photosensitive area; and a controller configured to receive signals from the outside, generate image information based on the received signals, and transmit the image information to the reflective display.

The controller may include an integrated controller to receive the signals from the outside, generate the image information based on the received signals, and control the reflective display based on the generated image information; and a control display linked to the reflective display to receive an image control input from a user and transmit the received image control signal to the integrated controller.

The windshield display system may further include a luminance sensor installed in the vehicle to sense the luminance of the photosensitive area, wherein the controller may be further configured to adjust the brightness of the reflective display based on the value from the luminance sensor.

The controller may be further configured to: control the brightness of the reflective display with increased activity as the luminance value from the luminance sensor increases, and control the brightness of the reflective display with reduced activity as the luminance value decreases.

The windshield display system may further include: an ultraviolet sensor installed in the vehicle and configured to sense the intensity of ultraviolet light outside the vehicle, wherein the controller may be further configured to adjust the brightness of the reflective display based on the value from the ultraviolet sensor.

The controller may be further configured to: control the brightness of the reflective display to decrease as the intensity of ultraviolet light sensed by the ultraviolet sensor increases; and control the brightness of the reflective display to increase as the intensity of ultraviolet light sensed by the ultraviolet sensor decreases.

The windshield display system may further include: a luminance sensor installed in the vehicle and configured to sense the luminance of the photosensitive area; and an ultraviolet sensor installed in the vehicle and configured to sense the intensity of ultraviolet light outside the vehicle, wherein the controller may be further configured to adjust the brightness of the reflective display based on the values from the luminance sensor and the ultraviolet sensor.

The windshield display system may further include a storage configured to store time information related to the change in transparency of the photosensitive area from transparent to opaque and from opaque to transparent, based on the intensity of ultraviolet light and whether ultraviolet light is incident, wherein the controller may be further configured to adjust the brightness of the reflective display based on the information stored in the storage.

The windshield display system may further include a heat dissipator configured to dissipate heat generated by the reflective display.

The photosensitive area may include an adhesive area where the windshield is bonded to a body of the vehicle.

### BRIEF DESCRIPTION OF THE DRAWINGS

FIG. 1 is a perspective view schematically illustrating a windshield reflective display of a windshield reflective display system according to the first embodiment of the present invention;

FIG. 2 is a schematic diagram of a windshield reflective display system according to the first embodiment of the present invention;

FIG. 3 is a schematic diagram of a windshield reflective display system according to the second embodiment of the present invention;

FIG. 4 is a schematic diagram of a windshield reflective display system according to the third embodiment of the present invention;

FIG. 5 is a graph illustrating the changes in the transmittance of the ultraviolet photosensitive coating based on the incidence of ultraviolet light;

FIG. 6 is a flowchart illustrating the process by which the integrated controller determines the state of the photosensitive area based on the changes in the transmittance of the ultraviolet photosensitive coating, as shown in FIG. 5; and

FIG. 7 is a perspective view schematically illustrating a windshield reflective display system according to the fourth embodiment of the present invention.

### DETAILED DESCRIPTION

The foregoing objectives, features, and advantages of the present invention will be more clearly understood through the following detailed description, taken in conjunction with the accompanying drawings. The specific structural or functional descriptions below are merely illustrative examples intended to describe embodiments of the present invention, and the embodiments of the present invention may be implemented in various forms and should not be construed as limited to those described in this specification or the application. The embodiments of the present invention may be subject to various modifications and may take on many different forms; therefore, specific embodiments are illustrated in the drawings and described in detail in this specification or the application. However, this should not be construed as limiting the embodiments of the present invention to the specific disclosed form, but should rather be understood to encompass all modifications, equivalents, or substitutes that fall within the scope of the concept and technological scope of the disclosure. The terms such as “first” and/or “second” may be used to describe various components, but the components are not limited to these terms. These terms are used solely for the purpose of distinguishing one component from another, so that, for example, the first component may be referred to as the second component without departing from the scope of the present invention, and similarly, the second component may also be referred to as the first component. When it is stated that a component is connected to or coupled to another component, it should be understood that the component may be directly connected to or coupled to the other component, or there may be other components interposed therebetween. On the other hand, when it is stated that a component is directly connected to or coupled with another component, it should be understood that there are no intermediate components between them. Other expressions used to describe the relationship between components, such as “between” and “directly between,” or “adjacent to” and “directly adjacent to,” should be interpreted in the same manner. The terms used in this specification are merely for the purpose of describing specific embodiments and are not intended to limit the present invention. The singular forms are intended to include the plural forms as well unless the context clearly indicates otherwise. The terms “include” or “comprise” used in this specification are intended to specify the presence of the described features, numbers, steps, actions, components, parts, or combinations thereof, and should not be understood as excluding the possibility of additional features, numbers, steps, actions, components, parts, or combinations thereof. Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein. To provide a detailed explanation of the present invention, preferred embodiments thereof will hereinafter be described with reference to the accompanying drawings. Like reference numerals refer to like elements throughout the drawings.

### First Embodiment

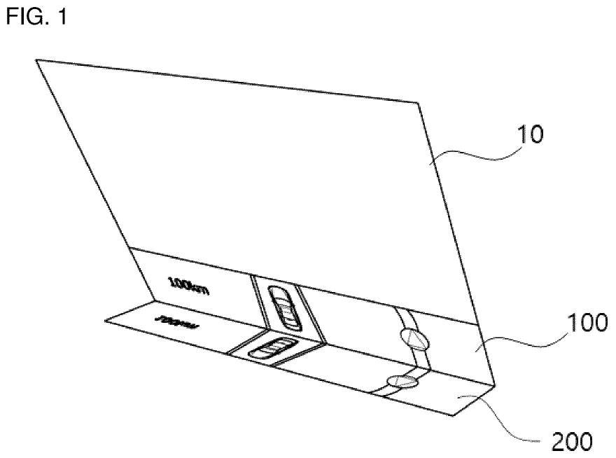

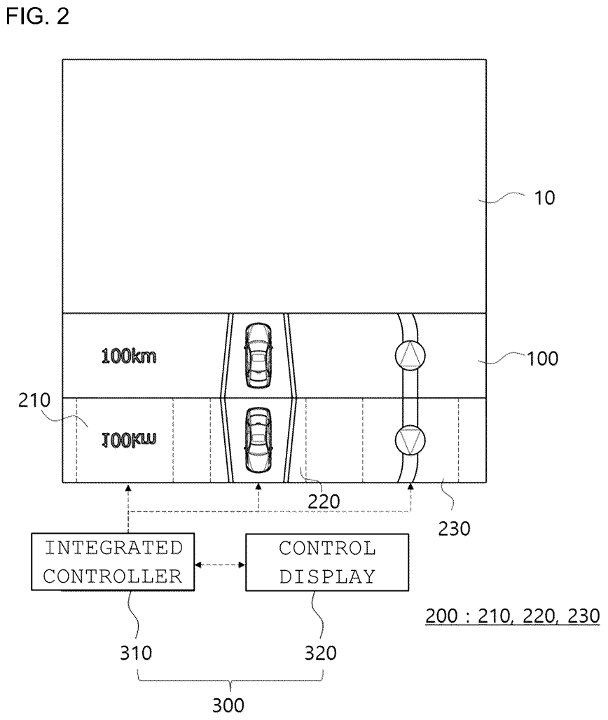

FIG. 1 is a perspective view schematically illustrating a windshield reflective display of a windshield reflective display system according to the first embodiment of the present invention, and FIG. 2 is a schematic diagram of a windshield reflective display system according to the first embodiment of the present invention.

As shown in FIGS. 1 and 2, the windshield reflective display system according to the first embodiment of the present invention is applied to the front windshield of a vehicle, that is, the windshield 10, and includes a photosensitive area 100, a reflective display 200, and a controller 300.

The photosensitive area 100 is formed by coating an ultraviolet photosensitive agent or attaching an ultraviolet photosensitive film to at least a portion of the vehicle's windshield 10. The ultraviolet photosensitive agent or ultraviolet photosensitive film has the characteristic of changing opacity depending on the intensity of the incident ultraviolet light. More specifically, when the incident ultraviolet light is strong, the opacity increases and the color becomes darker, while when the incident ultraviolet light is weak, the opacity decreases, making the area more transparent. Here, the color of the ultraviolet photosensitive agent or ultraviolet photosensitive film may be selected in various ways. For example, since the photosensitive area 100 is the part where the image output from the reflective display 200 is reflected, the ultraviolet photosensitive agent or ultraviolet photosensitive film constituting the photosensitive area 100 may be selected in relatively dark colors, such as black. However, the photosensitive area 100 does not completely block the transmission of light, but rather adopts a semi-transmissive approach. Coating the ultraviolet photosensitive agent or attaching the ultraviolet photosensitive film makes it easy to expand the photosensitive area 100, considering the driver's visibility.

In the windshield reflective display system according to the present invention, the photosensitive area 100, coated with an ultraviolet photosensitive agent or formed with an ultraviolet photosensitive film that changes its transparency depending on the intensity of the incident ultraviolet light, becomes transparent when the ultraviolet light intensity is weak, making it easier for the user to secure a clear forward view, while it becomes opaque when the ultraviolet light intensity is strong, facilitating easy viewing of the image output from the reflective display 200, thereby ensuring visibility.

The reflective display 200 is formed on the lower part of the windshield 10 and outputs an image, which is reflected by the photosensitive area 100. As shown in FIG. 2, the image output from the reflective display 200 may be in the opposite direction to the image visible in the photosensitive area 100. The reflective display 200 may incorporate local dimming technology or be implemented with microLEDs for relatively high brightness. Local dimming technology refers to a technique used to enhance the contrast ratio of a display by dividing the display into smaller areas and individually adjusting the brightness of each area, lowering the brightness of dark areas and increasing the brightness of bright areas.

As shown in FIG. 2, the reflective display 200 may be composed of a plurality of units, and in this embodiment, the reflective display 200 may include a first reflective display 210, a second reflective display 220, and a third reflective display 230.

The controller 300 receives signals from external sources, generates image information based on the received signals, and transmits this information to the reflective display 200. The reflective display 200 outputs the image information received from the controller. The controller 300 may include an integrated controller 310 and a control display 320 for the operations described above.

The integrated controller 310 receives signals from external sources, generates image information, and transmits the generated image information to the reflective display 200 to control the output of the image on the reflective display 200. The external source from which the integrated controller 310 receives signals may be the vehicle's main controller or a smart device such as a mobile phone. The integrated controller 310 may generate video information based on various data related to the vehicle's operation, such as the relative location of the vehicle to its lane, the location of surrounding vehicles, route information based on navigation, current driving information, and weather information for the area where the vehicle is located. The integrated controller 310 may be implemented as an electronic component or an electronic device that includes the electronic components necessary for the above operations. Here, the electronic component may include a type of semiconductor device and may be programmed to carry out the aforementioned operations.

The control display 320 is linked to the reflective display 200. This means that at least one of the information or images output by the reflective display 200 is also displayed on the control display 320. In addition to being linked with the reflective display 200, the control display 320 may be configured to allow the user to manipulate the type of image displayed on the reflective display 200. In other words, the user can operate the control display 320 to change the image displayed on the reflective display 200. To achieve this, the control display 320 may be installed inside the vehicle, and for user operation, may be implemented in a form with a touch panel, buttons for operation, or a combination of both touch panel and buttons.

In this embodiment, the photosensitive area 100 may be coated with an anti-double-image coating or attached with an anti-double-image film. Generally, the windshield 10 is manufactured with a film attached between two pieces of glass for the safety of the occupants, which may cause the image reflected in the photosensitive area 100 to appear as a double image, making it difficult to ensure clear visibility. The anti-double image film or anti-double image coating included in this embodiment is intended to prevent this issue.

The photosensitive area 100 may be included in the adhesive area where the windshield 10 is bonded to the vehicle's body. This aims to make the best use of the opaque area that already exists, formed by the adhesive bonding the windshield 10 to the vehicle body.

### Second Embodiment

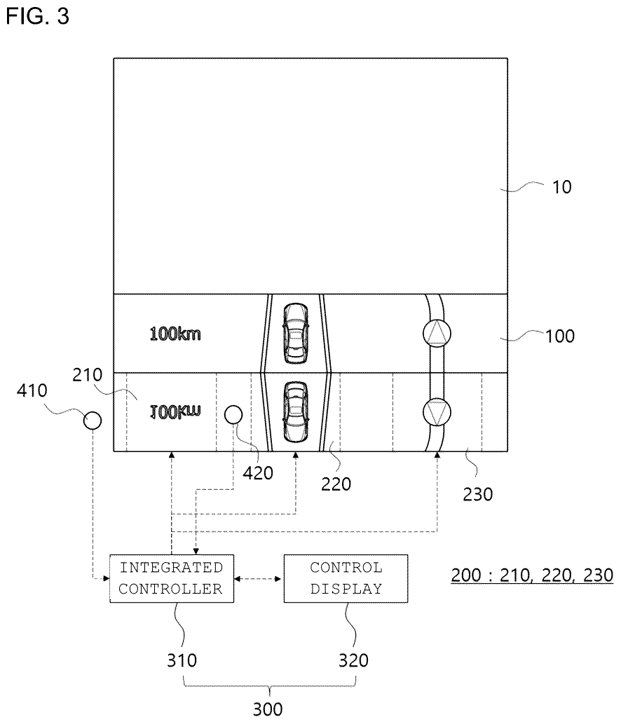

FIG. 3 is a schematic diagram of a windshield reflective display system according to the second embodiment of the present invention.

As shown in FIG. 3, the windshield reflective display system according to the second embodiment of the present invention additionally includes an ultraviolet sensor 410 and a luminance sensor 420 in the windshield reflective display system of the first embodiment described earlier, and the integrated controller 310 included in the controller 300 adjusts the brightness of the reflective display 200 based on the sensing values from the ultraviolet sensor 410 and the luminance sensor 420.

The ultraviolet sensor 410 is installed on the vehicle to sense the intensity of ultraviolet light incident from outside the vehicle. The transparency of the photosensitive area 100 varies depending on the intensity of ultraviolet light detected by the ultraviolet sensor 410. Specifically, the photosensitive area 100 becomes more opaque (darker) when exposed to strong ultraviolet light and becomes more transparent when exposed to weak ultraviolet light.

The luminance sensor 420 is installed on the vehicle to sense the brightness inside the vehicle. The luminance sensor 420 may be installed inside the vehicle where the driver's seat is located or outside the vehicle. The luminance sensor 420 may be the same as the sensor used for the vehicle's auto light function (which automatically turns the headlights on or off based on the ambient light level in the vehicle's location).

The integrated controller 310 may adjust the brightness of the reflective display 200 based on the values sensed by the ultraviolet sensor 410 and the luminance sensor 420. The integrated controller 310 generally adjusts the brightness of the reflective display 200 to be lower when the ultraviolet intensity sensed by the ultraviolet sensor 410 is high and to be higher when the ultraviolet intensity is low. This is because, when the ultraviolet intensity is high, the photosensitive area 100 becomes opaque, so even when the brightness of the reflective display 200 is reduced, visibility is not compromised.

Additionally, the integrated controller 310 adjusts the brightness of the reflective display 200 to be stronger as the luminance value from the luminance sensor 420 increases and weaker as the luminance value decreases. Similarly, when the internal luminance of the vehicle is low, even though the brightness of the reflective display 200 is reduced, visibility is not compromised.

The process of the integrated controller 310 controlling the brightness of the reflective display 200 based on the sensing values from both the ultraviolet sensor 410 and the luminance sensor 420 will now be described in detail. The integrated controller 310 may categorize the intensity of ultraviolet light entering the vehicle into 0 to 4 based on predetermined criteria, and the luminance of the space where the vehicle is located may also be classified into 1 to 3. In this range, lower numbers indicate weaker ultraviolet light and luminance, while higher numbers indicate stronger ultraviolet light and luminance. The integrated controller 310 may control the brightness of the reflective display 200 based on the sum of two numbers derived from the values sensed by the ultraviolet sensor 410 and the luminance sensor 420. The range of the sum of the two numbers, based on the values sensed by the ultraviolet sensor 410 and the luminance sensor 420, is between 1 and 7. When the sum of the two numbers is highest at 7, the integrated controller 310 may control the brightness of the reflective display 200 at 100%, and when the sum is lowest at 1, the brightness may be controlled at 70%, with the brightness adjusted proportionally for values between 1 and 7. This method, which adjusts the brightness of the reflective display 200 based on the sensing values from both the ultraviolet sensor 410 and the luminance sensor 420, enables the implementation of the windshield reflective display system according to the present invention with more efficient power consumption.

In this embodiment, the integrated controller 310 adjusts the brightness of the reflective display 200 based on the sensing values from both the luminance sensor 420 and the ultraviolet sensor 410, but it is also possible for the windshield reflective display system according to the present invention to include only one of the luminance sensor 420 or the ultraviolet sensor 410, adjusting the brightness of the reflective display 200 based solely on the sensing value from the included sensor.

### Third Embodiment

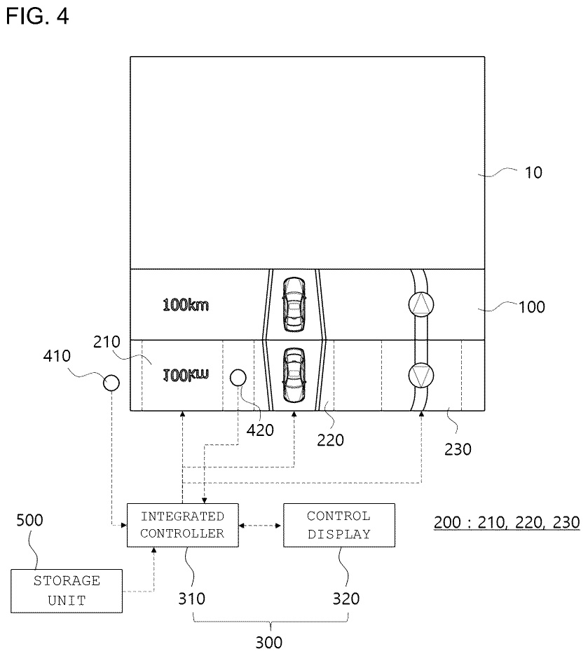

FIG. 4 is a schematic diagram of a windshield reflective display system according to the third embodiment of the present invention.

As shown in FIG. 4, the windshield reflective display system according to the third embodiment of the present invention further includes a storage 500 in the windshield reflective display system according to the second embodiment of the present invention described earlier.

The ultraviolet photosensitive coating or ultraviolet photosensitive film on the photosensitive area 100 changes transparency when ultraviolet light is incident, but this change takes time. Typically, ultraviolet photosensitive materials take a short time to change from a transparent state to an opaque state such as black, and take a longer time to change from an opaque state to a transparent state. Here, a short time may be several seconds to tens of seconds, and a long time may be several minutes. The integrated controller 310 may not directly measure the current state of the photosensitive area 100 (whether it is transparent or opaque, or the degree of opacity). Therefore, the integrated controller 310 estimates the change in transparency of the photosensitive area 100 using the sensing value of the ultraviolet sensor 410 and adjusts the brightness of the reflective display 200 based on the estimated state of the photosensitive area 100.

The storage 500 stores time information on how long it takes for the transparency of the photosensitive area 100 to change from transparent to opaque and from opaque to transparent, depending on the intensity of the ultraviolet light and whether ultraviolet light is incident. The storage 500 may be implemented as a type of memory device, and the integrated controller 310 changes and adjusts the brightness of the reflective display 200 based on the information stored in the storage 500.

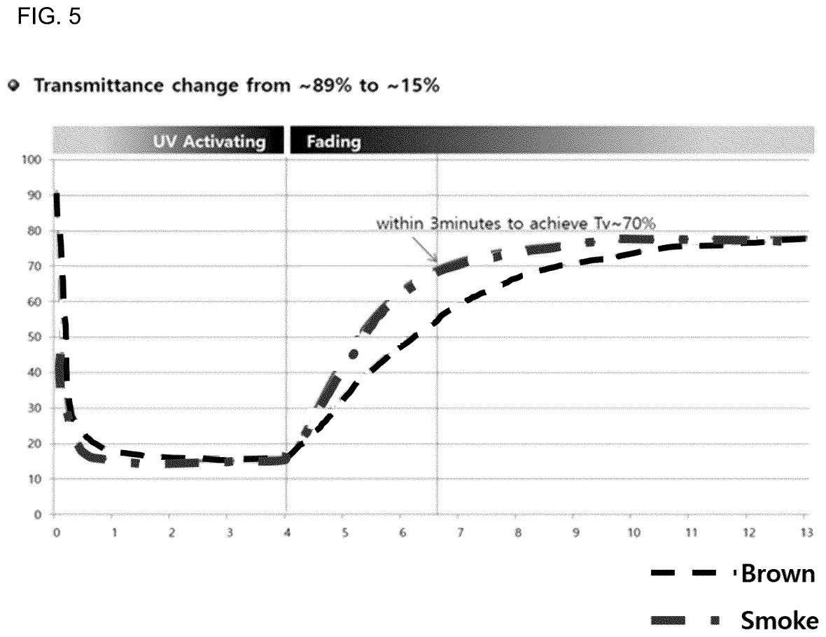

FIG. 5 is a graph illustrating the changes in the transmittance of the ultraviolet photosensitive coating based on the incidence of ultraviolet light.

In FIG. 5, the vertical axis represents light transmittance, where 100% indicates full transparency and 0% indicates complete opacity. In FIG. 5, the horizontal axis represents time, with “UV Activating” referring to the state when ultraviolet (UV) light is incident, and “Fading” referring to the state where ultraviolet light is not incident, causing the transition from opaque to transparent. The storage 500 may store the information as shown in FIG. 5.

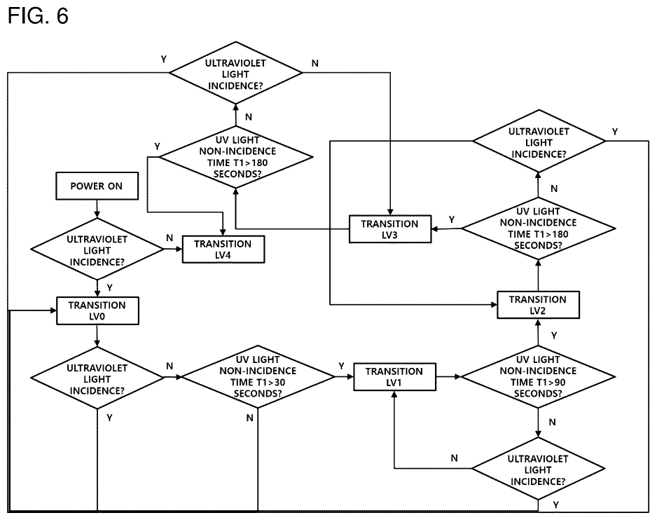

FIG. 6 is a flowchart illustrating the process by which the integrated controller determines the state of the photosensitive area based on the changes in the transmittance of the ultraviolet photosensitive coating, as shown in FIG. 5. In the flowchart shown in FIG. 6, it is assumed that the transparency of the photosensitive area 100 is categorized into five levels, from LV0 to LV4, with LV0 corresponding to 15% transmission of incident light, LV1 to 30%, LV2 to 50%, LV3 to 70%, and LV4 to 90%, all set arbitrarily.

First, when the vehicle is started, the integrated controller 310 determines whether ultraviolet light is entering based on the sensing values from the ultraviolet sensor 410. When it is determined that no ultraviolet light is entering based on the sensing values from the ultraviolet sensor 410, the integrated controller 310 may determine that the photosensitive area 100 is in the most transparent state, LV4. When it is determined that ultraviolet light is entering based on the sensing values from the ultraviolet sensor 410, the integrated controller 310 may determine the photosensitive area 100 has changed to LV0 due to the relatively rapid transition from transparent to opaque. Subsequently, the integrated controller 310 checks whether ultraviolet light is continuously entering the vehicle based on the sensing values from the ultraviolet sensor 410. Upon determining that the ultraviolet light entry was stopped based on the sensing value from the ultraviolet sensor 410, the integrated controller 310 checks how long this interruption has lasted. For example, the integrated controller 310 may determine that the transparency of the photosensitive area 100 has changed to LV1 for the time T1, during which ultraviolet light entry was stopped, exceeding 30 seconds, LV2 for T1 exceeding 90 seconds, LV3 for T1 exceeding 180 seconds, and LV4 for T1 exceeding 300 seconds. Here, the criteria of 30 seconds, 90 seconds, 180 seconds, and 300 seconds mentioned here may be stored in the storage 500, and this information may vary depending on factors such as the type of ultraviolet photosensitive material and its applied thickness.

### Fourth Embodiment

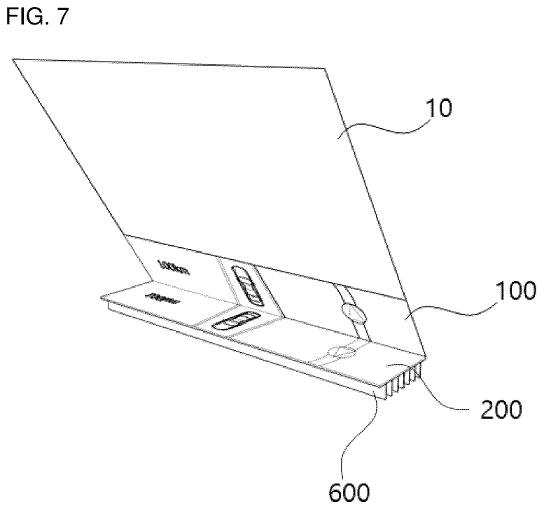

FIG. 7 is a perspective view schematically illustrating a windshield reflective display system according to the fourth embodiment of the present invention.

As shown in FIG. 7, the windshield reflective display system according to the fourth embodiment of the present invention further includes a pin 600 for heat dissipation in the windshield reflective display system according to the first embodiment of the present invention described earlier.

The pin 600 releases the heat generated by the reflective display 200, ensuring that the reflective display 200 operates normally. The pin 600 may be implemented in a form where multiple plates are arranged in parallel with each other, increasing the heat contact area of the reflective display 200 and efficiently releasing the heat generated during the high-brightness (high-luminance) operation of the reflective display 200 to the outside. The pin 600 may be made of a material with a high thermal conductivity, such as copper, aluminum, copper alloy, or aluminum alloy.

The pin 600 alone may be insufficient to release the heat generated during the high-luminance operation of the reflective display 200. To overcome this, a fan may be further included in the heat dissipation section. The fan circulates air toward the reflective display 200, more specifically toward the pin 600, enhancing heat dissipation.

The fan may be configured to operate always or as needed. For example, the fan may be activated by the integrated controller 310 when the brightness of the reflective display 200 exceeds 90% of its maximum and deactivated when the brightness falls below 90%, thereby improving the operational efficiency of the system.

While the above embodiment includes a fan in conjunction with the pin 600, it should be noted that embodiments without the pin 600 but with only the fan are also possible.

A windshield reflective display system of various embodiments of the present invention is advantageous in terms of allowing the driver to ensure visibility of the image reflected in the photosensitive area by adjusting the opacity of the photosensitive area, which is formed by coating or attaching an ultraviolet photosensitive agent or ultraviolet photosensitive film, according to the incidence of ultraviolet light without the need for separate control, while also making it easier to maintain visibility even when the photosensitive area becomes transparent.

A windshield reflective display system of various embodiments of the present invention is also advantageous in terms of improving the power consumption efficiency of the reflective display by adjusting its brightness (luminance) based on the opacity of the photosensitive area and the vehicle's interior conditions, which are estimated using sensing values from ultraviolet and illumination sensors.

A windshield reflective display system of various embodiments of the present invention is also advantageous in terms of improving operational efficiency by enabling the integrated controller to adjust the brightness of the reflective display based on time information stored in the storage, which indicates changes in the opacity of the photosensitive area depending on the incidence of ultraviolet light.

A windshield reflective display system of various embodiments of the present invention is also advantageous in terms of improving the lifespan and reliability of the reflective display by including a heat dissipator that facilitates the release of heat generated during high-brightness operation of the reflective display.

A windshield reflective display system of various embodiments of the present invention is also advantageous in terms of managing heat more efficiently by including a heat dissipator with a fan that operates only when the reflective display functions at high brightness.

A windshield reflective display system of various embodiments of the present invention is also advantageous in terms of preventing double imaging by applying an anti-double-image coating or attaching an anti-double-image film to the photosensitive area.

A windshield reflective display system of various embodiments of the present invention is also advantageous in terms of enabling more efficient implementation by incorporating the photosensitive area into the adhesive region between the windshield and the vehicle body, utilizing the opaque area created by the adhesive.

While preferred embodiments of the present invention have been described above, the embodiments disclosed herein are intended to be illustrative and not limiting of the scope of the invention. Accordingly, the technical scope of the invention is not limited to the disclosed embodiments but encompasses combinations of the disclosed embodiments, and the scope of the invention is not limited by these embodiments. Furthermore, it will be apparent to those skilled in the art that various changes and modifications can be made to the present invention without departing from the spirit or scope of the attached claims, and all such variations and modifications are intended to fall within the scope of the present invention.

### DESCRIPTION OF REFERENCE NUMERALS

10: windshield

100: photosensitive area

200: reflective display

210~230: first to third reflective display

300: controller

310: integrated controller

320: control display

410: ultraviolet sensor

420: luminance sensor

500: storage

600: pin

What is claimed is:

1. A windshield display system comprising:
a photosensitive area formed on at least a portion of a windshield of a vehicle by coating ultraviolet photosensitive agent or attaching an ultraviolet photosensitive film to the windshield, the photosensitive area configured to change transparency based on incident ultraviolet light;
a reflective display formed on a lower part of the windshield and configured to output an image and reflect the image onto the photosensitive area; and
a controller configured to receive signals from the outside, generate image information based on the received signals, and transmit the image information to the reflective display.

2. The windshield display system of claim 1, where in the controller comprises:
an integrated controller configured to receive the signals from the outside, generate the image information based on the received signals, and control the reflective display based on the generated image information; and
a control display linked to the reflective display to receive an image control input from a user and transmit the received image control signal to the integrated controller.

3. The windshield display system of claim 1, further comprising:
a luminance sensor installed in the vehicle to sense the luminance of the photosensitive area,
wherein the controller is further configured to adjust the brightness of the reflective display based on the value from the luminance sensor.

4. The windshield display system of claim 3, wherein the controller is further configured to:
control the brightness of the reflective display with increased activity as the luminance value from the luminance sensor increases, and
control the brightness of the reflective display with reduced activity as the luminance value decreases.

5. The windshield display system of claim 1, further comprising:
an ultraviolet sensor installed in the vehicle and configured to sense the intensity of ultraviolet light outside the vehicle,
wherein the controller is further configured to adjust the brightness of the reflective display based on the value from the ultraviolet sensor.

6. The windshield display system of claim 5, wherein the controller is further configured to:
control the brightness of the reflective display to decrease as the intensity of ultraviolet light sensed by the ultraviolet sensor increases; and
control the brightness of the reflective display to increase as the intensity of ultraviolet light sensed by the ultraviolet sensor decreases.

7. The windshield display system of claim 1, further comprising:
a luminance sensor installed in the vehicle and configured to sense the luminance of the photosensitive area; and
an ultraviolet sensor installed in the vehicle and configured to sense the intensity of ultraviolet light outside the vehicle,
wherein the controller is further configured to adjust the brightness of the reflective display based on the values from the luminance sensor and the ultraviolet sensor.

8. The windshield display system of claim 5, further comprising:
a storage configured to store time information related to the change in transparency of the photosensitive area from transparent to opaque and from opaque to transparent, based on the intensity of ultraviolet light and whether ultraviolet light is incident,
wherein the controller is further configured to adjust the brightness of the reflective display based on the information stored in the storage.

9. The windshield display system of claim 6, further comprising:
a storage configured to store time information related to the change in transparency of the photosensitive area from transparent to opaque and from opaque to transparent, based on the intensity of ultraviolet light and whether ultraviolet light is incident,
wherein the controller is further configured to adjust the brightness of the reflective display based on the information stored in the storage.

10. The windshield display system of claim 7, further comprising:
a storage configured to store time information related to the change in transparency of the photosensitive area from transparent to opaque and from opaque to transparent, based on the intensity of ultraviolet light and whether ultraviolet light is incident,
wherein the controller is further configured to adjust the brightness of the reflective display based on the information stored in the storage.

11. The windshield display system of claim 1, further comprising:
a heat dissipator configured to dissipate heat generated by the reflective display.

12. The windshield display system of claim 1, wherein the photosensitive area comprises an adhesive area where the windshield is bonded to a body of the vehicle.
